(19) United States
(12) Patent Application Publication
(10) Pub. No.: US 2024/0301644 A1
(43) Pub. Date: Sep. 12, 2024

(54) Screen Cleaning Device for Cleaning a Bar Rack of a Screen, and Screen

(71) Applicant: HUBER SE, Berching (DE)

(72) Inventor: Benedikt Billner, Greding - Herrnsberg (DE)

(21) Appl. No.: 18/595,900

(22) Filed: Mar. 5, 2024

(30) Foreign Application Priority Data
Mar. 8, 2023 (DE) 10 2023 105 754.5

(51) Int. Cl. E02B 8/02; B66D 1/60

(52) U.S. Cl. CPC E02B 8/026; B66D 1/60; B66D 2700/0183

(57) ABSTRACT

In one aspect, a screen cleaning device for cleaning a bar rack of a screen includes at least one clearing element for picking up and removing screenings retained by the screen. The screen cleaning device also includes a lifting winch relative to which a first pulling means and a second pulling means can be wound and unwound, wherein the clearing element is moved along a lifting direction as the pulling means are wound and unwound. Additionally, the screen cleaning device includes at least one actuating device configured to manipulate the second pulling means such that the clearing element is swiveled between a clearing position and an open position. The second pulling means is connected to the lifting winch at a first end and to the actuating device at a second end. Moreover, the second pulling means is guided via a return mechanism which is mounted on the clearing element.

### CROSS-REFERENCE TO RELATED APPLICATIONS

The present application is based upon and claims the right of priority to German Patent Application No. 10 2023 105 754.5, filed Mar. 8, 2023, the disclosure of which is hereby incorporated by reference herein in its entirety for all purposes.

### FIELD OF THE INVENTION

The present subject matter relates to a screen cleaning device for cleaning a bar rack of a screen, the screen being used to separate out and remove screenings from a flowing liquid, for example, wastewater. The screen cleaning device includes at least one clearing element for picking up and removing the screenings which are retained by the screen, including a lifting winch, by means of which a first pulling means and a second pulling means can be wound and unwound. The cleaning element is moved along a lifting direction as the pulling means are wound and unwound. The screen cleaning device further includes at least one actuating device, by means of which the second pulling means can be manipulated such that the clearing element is pivoted between a clearing position and a discharge position when the second pulling means is manipulated. The present subject matter also relates to a screen.

### BACKGROUND

DE 1 731 985 U describes a movable device which includes a cleaning rake, which is swiveled by means of swivel cables and is guided upward and downward by means of lifting cables, for cleaning water intake screens. The cleaning rake is driven, for example, by means of a double cable winch. In order to swivel the cleaning rake outward, the length of the swivel cable is shortened in relation to the length of the lifting cable via the action of a swivel roller. It is disadvantageous that the swivel roller for swiveling the cleaning rake is intensely loaded by the weight force of the cleaning rake and by the attached swivel cable. In addition, the swivel roller must also be laterally pushed by means of a guide plate as the swivel cable is wound and unwound, as a result of which the swivel cable and the swivel roller are loaded.

Therefore, a need exists for a cleaning device that eliminates one or more of the the disadvantages known from the prior art. For example, a need exists for a cleaning device for cleaning a bar rack that facilitates the swiveling of the clearing element and/or improves the winding and unwinding of the pulling means on the lifting winch.

### SUMMARY OF THE INVENTION

In various aspects, the present subject matter is directed to a cleaning device and a screen having the features described and claim herein.

In one aspect, the present subject matter to a screen cleaning device for cleaning a bar rack of a screen, the screen being used to separate out and remove screenings from a flowing liquid, for example, wastewater. Screens of this type are used, for example, as intake screens or water intake screens for pump stations, seawater removal systems, hydro-electric power plants and/or sewage treatment plants.

The screen cleaning device includes at least one clearing element for picking up and removing the screenings which are retained by the screen. The clearing element can include, for example, rake teeth, which can at least partially engage into the bar rack. In this way, the screenings which accumulate in front of the screen on the bar rack can be picked up by the clearing element.

The screen cleaning device also includes a lifting winch, by means of which a first pulling means and a second pulling means can be wound and unwound, the clearing element being moved along a lifting direction as the pulling means are wound and unwound. When the pulling means are wound, at least the first pulling means acts on the clearing element such that the clearing element is moved upward along the lifting direction. Due to the weight of the clearing element, the clearing element is moved downward along the lifting direction when the pulling means are unwound. The lifting direction should be understood to be the direction along which the clearing element is moved upward and downward. The lifting direction can extend substantially vertically.

This corresponds to an installation angle of the screen of 90°. It is also possible that the screen is installed in an inclined position and, for example, assumes an installation angle in the range between 50° and 90°.

In addition, the screen cleaning device includes at least one actuating device, by means of which the second pulling means can be manipulated such that the clearing element is pivoted between a clearing position and an open position when the second pulling means is manipulated.

In order to ensure that the screenings can be picked up by the clearing element, the clearing element is moved downward preferably in the open position by means of the lifting winch. In the open position, a passage cross-section for the screenings located on the bar rack is formed between the clearing element and the screen. The clearing element does not act on the screenings when moving downward. Once the clearing element has reached the lower end point of the bar rack (the channel bottom), the clearing element is moved or swiveled from the open position into the clearing position by means of the actuating device. In the clearing position, the clearing element rests against the bar rack, in particular with a shovel surface and/or by means of the rake teeth mounted on the shovel surface, such that the screenings are picked up and moved along during the upward movement.

A clearing position should therefore be understood to be the position of the clearing element, in which the clearing element can clear or remove the screenings from the bar rack. At the upper end point, the screenings are removed from the clearing element by means of a scraper. Thereafter, the clearing element can be swiveled back into the open position by means of the actuating device.

According to one aspect of the present subject matter, the second pulling means are connected to the lifting winch at a first end and to the actuating device at a second end and are guided via a return mechanism mounted on the clearing element. Therefore, the second pulling means can be wound and unwound by means of the lifting winch when the clearing element is moved along the lifting direction. The return mechanism of the second pulling means therefore moves together with the clearing element along the lifting direction.

In order to swivel the clearing element, the actuating device can act in a manipulating manner via the second end of the second pulling means. It is conceivable, for example, that the actuating device for manipulating the second pulling means translationally displaces the second end, for example, by means of a linear drive or an actuating cylinder, and/or winds or unwinds the second pulling means by securing the second end on an actuating winch. Due to this manipulation, the effective length and/or the engagement angle of the second pulling means changes, as a result of which the return mechanism is moved. The movement of the return mechanism brings about the swiveling of the clearing element, in particular about a swivel point and/or a swivel axis. The swivel point and/or the swivel axis are/is preferably arranged in the region of a mounting of the first pulling means and/or a third pulling means on the clearing element.

As a result, the first pulling means and the second pulling means can be wound and unwound, preferably uniformly, by means of the lifting winch. Since the lifting winch and the actuating device act on the second pulling means on different sides of the return mechanism, mutual interference is reduced. A slight transverse movement or angle change of the second pulling means from the lifting winch to the return mechanism mounted on the clearing element can occur during the winding and unwinding on the lifting winch.

The actuating device acting on the second pulling means on the other side of the return mechanism is unaffected by this transverse movement or angle change, as a result of which these do not need to be compensated for.

It is advantageous when the screen cleaning device includes a third pulling means, which can be wound and unwound by means of the lifting winch. The upward and downward movements of the clearing element along the lifting direction can be stabilized by means of the third pulling means. In addition, the weight force of the clearing element can be more uniformly transmitted onto the lifting winch in this way. Preferably, the first pulling means and the third pulling means are spaced apart from one another along a transverse direction of the screen cleaning device and/or are arranged at the ends of the clearing element. An additional guidance of the clearing element can therefore be dispensed with, or the guidance can be operated free from a transverse load. It is also advantageous when the second pulling means is arranged between the first pulling means and the third pulling means along the transverse direction. As a result, the three pulling means are distributed as uniformly as possible along the transverse direction. Preferably, the first pulling means and the third pulling means hold substantially the same weight force of the clearing element. The second pulling means is only responsible for swiveling the clearing element between the clearing position and the open position.

It is additionally advantageous when at least one of the pulling means is in the form of a cable, in particular a wire rope and/or a steel cable, or a chain, in particular a link chain. Preferably, the first pulling means is in the form of a lifting cable or a lifting chain and/or the second pulling means is in the form of a control cable or control chain and/or the third pulling means is in the form of a lifting cable or lifting chain. The first pulling means and/or the third pulling means are therefore in the form of a lifting cable or lifting chain for moving the clearing element upward and downward and/or for holding its weight force. The second pulling means, which is in the form of a control cable or a control chain, is designed to swivel the clearing element between the clearing position and the open position.

It is also advantageous when the lifting winch includes at least one drum for winding and unwinding the pulling means and/or one drum shaft for winding and unwinding the pulling means or for accommodating the at least one drum. When the pulling means are wound and unwound, these are laid next to one another along the transverse direction. The width along which these are laid next to one another can be delimited along the transverse direction by means of the at least one drum. As a result, the pulling means can be prevented from coming into contact with one another on the lifting winch. The individual drums can be driven uniformly and/or at a ratio with respect to one another by means of the drum shaft. It is also conceivable that the pulling means are wound and unwound on the drum shaft. This results in a simpler and/or more cost-effective design of the lifting winch.

It is also advantageous when a plurality of drums is accommodated on the drum shaft, with one of the drums preferably being associated with a respective one of the pulling means and/or the drums preferably being indirectly mechanically coupled to one another via the drum shaft. In this way, the pulling means can be synchronously wound and unwound on the respective drum.

Moreover, it is advantageous when the at least one drum is divisible into at least two drum elements. The divisible drum can be easily mounted and/or exchanged onto an existing drum shaft. The drum is, additionally or alternatively, made of a polymeric material, which results in the associated pulling means being wound and unwound on the lifting winch in the most gentle and protective manner possible. In addition, as a result, the cleaning device can be operated more quietly. Additionally or alternatively, the drum is made from metal, in particular from steel, cast iron or aluminum. The wear on the drum can therefore be reduced.

It is advantageous when the actuating device includes, as an actuating winch, an actuating drive and/or an actuating drum, the actuating drive preferably driving the actuating drum to wind and unwind the second pulling means. As a result, the second pulling means can be manipulated by the actuating winch during winding and unwinding. The second end of the second pulling means is therefore secured in the region of the actuating drum and is wound and unwound by means of the actuating drive, as a result of which the clearing element is swiveled.

It is also advantageous when a drum-side end of the first pulling means and/or of the third pulling means is connected to the lifting winch and a bearing-side end of the first pulling means and/or of the third pulling means is connected to at least one bearing device. The drum-side end is preferably secured on the associated drum. The bearing-side end is secured on the bearing device.

It is additionally advantageous when the at least one drum, the drum shaft and/or the actuating drum are/is provided with grooving on the periphery such that the pulling means which are associated with the drum, the drum shaft and/or the actuating drum can be wound and unwound inside the grooving preferably in one layer and/or in the same number of layers. In this way, the associated pulling means can be wound and unwound as uniformly as possible.

Moreover, it is advantageous when the cleaning device includes at least one further return mechanism for deflecting the first pulling means and/or the third pulling means. The at least one further return mechanism is preferably mounted on the clearing element. The drum-side end and the bearing-side end of the first pulling means and/or of the third pulling means are located on different sides of the further return mechanism. If the first pulling means and/or the third pulling means are wound or unwound by means of the lifting winch, the clearing element mounted on the further return mechanism moves along the lifting direction.

It is additionally advantageous when the cleaning device includes two bearing devices and two further return mechanisms for the first pulling means and the third pulling means. The bearing devices and/or the further return mechanisms are preferably spaced apart from one another along the transverse direction such that the pulling means extend with as little offset as possible. In this way, the clearing element can be moved along the lifting direction as uniformly as possible.

It is also advantageous when the return mechanism and/or the actuating device are/is arranged along the transverse direction, in particular substantially in the center, between the two bearing devices and/or the two further return mechanisms. As a result, the actuating device is arranged in the center between the two bearing rollers of the bearing elements.

It is advantageous when the at least one bearing device has a bearing roller, via which the first pulling means and/or the third pulling means are guided and/or deflected. In this way, the first pulling means and/or the third pulling means can be deflected in a gentle manner via the bearing roller. The bearing-side end of the first pulling means and/or of the third pulling means can be geometrically displaced by means of the bearing roller such that easier accessibility is ensured. An installation height of the screen cleaning device can also be reduced due to the deflection of the first pulling means and/or of the third pulling means by the bearing roller, thereby allowing a necessary spacing to be provided between the lifting winch and the bearing device at least partially transversely to the lifting direction.

It is additionally advantageous when the at least one bearing device includes at least one spring, on which the bearing-side end of the first pulling means and/or of the third pulling means are/is secured. The external effects, for example, forces acting on the clearing element and/or vibrations of the clearing elements, can be compensated for by means of the spring. These forces can be redirected and/or transmitted to the spring by means of the bearing roller.

It is advantageous when the lifting winch includes a lifting drive, the lifting drive driving the drum shaft. Preferably, the lifting drive is laterally connected to the drum shaft. In addition, the lifting winch can include a gear mechanism for converting the drive rotational speed of the lifting drive to the shaft rotational speed of the drum shaft.

It is also advantageous when the screen cleaning device includes a control unit, which is preferably operatively connected to the lifting drive, in particular by means of a frequency converter, and/or to the actuating device, in particular by means of a contactor. The screen cleaning device can be controlled by means of the control unit such that, during a lifting operation, the actuating device is stopped and the clearing element is held in the current position (open position or clearing position). The screen cleaning device can be controlled such that the lifting winch is stopped during the swiveling of the clearing element between the clearing position and the open position.

It is also advantageous when the control unit is in the form of a programmable logic controller (PLC). As a result, the screen cleaning device can be operated in a more flexible and more reliable manner. In addition, this can allow remote maintenance to be simplified.

It is advantageous when the screen cleaning device includes at least one sensor, in particular a position switch, a gearbox limit switch and/or a rotary encoder or encoder, for detecting the position of the lifting winch, of the lifting drive, of the actuating drive, of the actuating device and/or of the clearing element. The at least one sensor is preferably arranged in the region of the lifting winch, of the lifting drive, of the actuating drive, of the actuating device and/or of the clearing element. In this way, the position, in particular the upper end position and/or the lower end position, of the clearing element can always be detected. If the sensor is in the form of a gearbox limit switch, the detection of the end positions of the clearing element is ensured in the simplest and most robust manner possible.

It is additionally advantageous when the at least one sensor is operatively connected to the control unit. In this way, the lifting drive and/or the actuating device can be controlled as efficiently as possible according to the detected position of the clearing element.

It is also advantageous when the sensor, which is in the form, in particular, of a gearbox limit switch, includes the at least one encoder, at least one potentiometer and/or the at least one rotary encoder. Additionally or alternatively, it is advantageous when the sensor is operatively connected to the at least one encoder, potentiometer and/or rotary encoder. In this way, the information from the gearbox limit switch can be used to measure displacement.

In addition, it is advantageous when the screen cleaning device has a frame. Advantageously, the lifting winch, the actuating device, the bearing device, the control unit and/or the at least one sensor are/is accommodated on the frame. For example, the lifting drive of the lifting winch, the actuating drive of the actuating winch, the control unit, the at least one sensor and/or the at least one spring of the bearing device can be non-displaceably arranged on the frame. In addition or alternatively, the drum shaft, the at least one drum, the actuating drum and/or the bearing roller can be rotatably arranged on the frame, for example, by means of at least one radial bearing. The screen cleaning device can rest against the screen or be connected to the screen by means of the frame for cleaning the bar rack.

The present subject matter further relates to a screen for separating out and removing screenings from a flowing liquid, for example, wastewater, which includes a bar rack and a screen cleaning device. The screen cleaning device can be designed according to the preceding description, wherein the aforementioned features can be present individually or in any combination.

The bar rack can also be designed according to the preceding description.

### BRIEF DESCRIPTION OF THE FIGURES

Further advantages of the invention are described in the following exemplary embodiments, wherein:

FIG. 1 shows a perspective view of a screen cleaning device, and

FIGS. 2 and 3 show schematically cutaway side views of a screen cleaning device arranged on a screen according to another exemplary embodiment.

### DETAILED DESCRIPTION

In the following description of the figures, the same reference characters are used for features that are identical and/or at least comparable in each of the various figures. The individual features, their embodiment and/or mode of operation are explained in detail usually only upon the first mention thereof. If individual features are not explained in detail once more, their embodiment and/or mode of operation correspond(s) to the embodiment and mode of operation of the identically-acting or identically-named features described above.

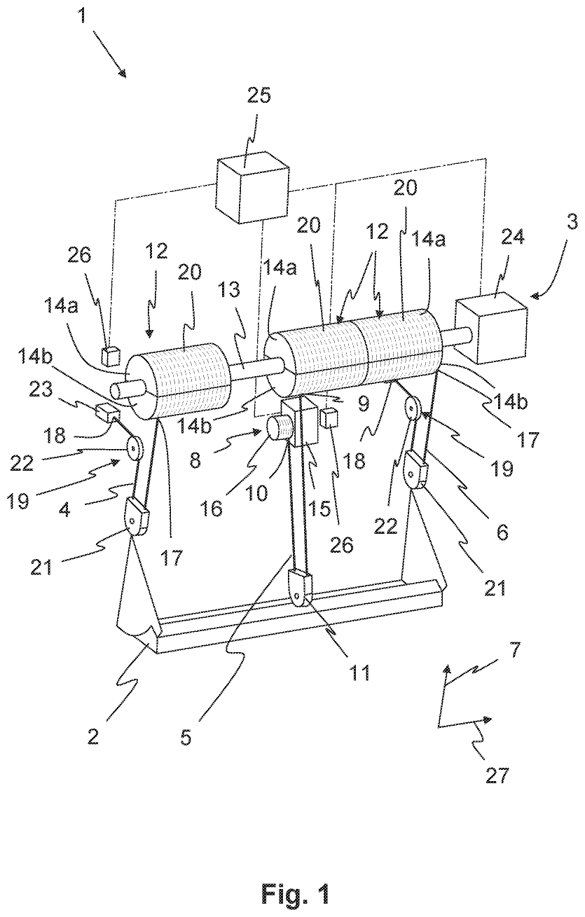

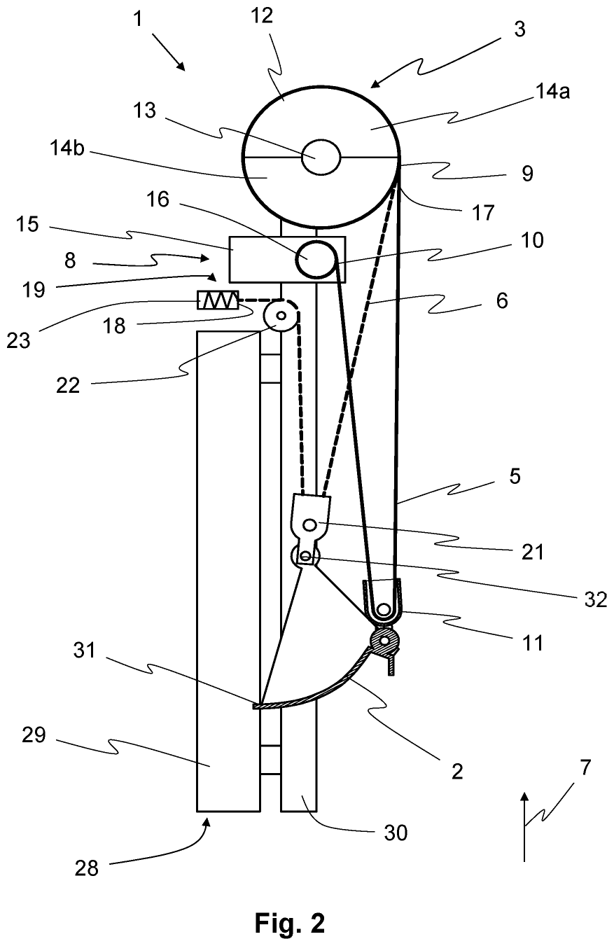

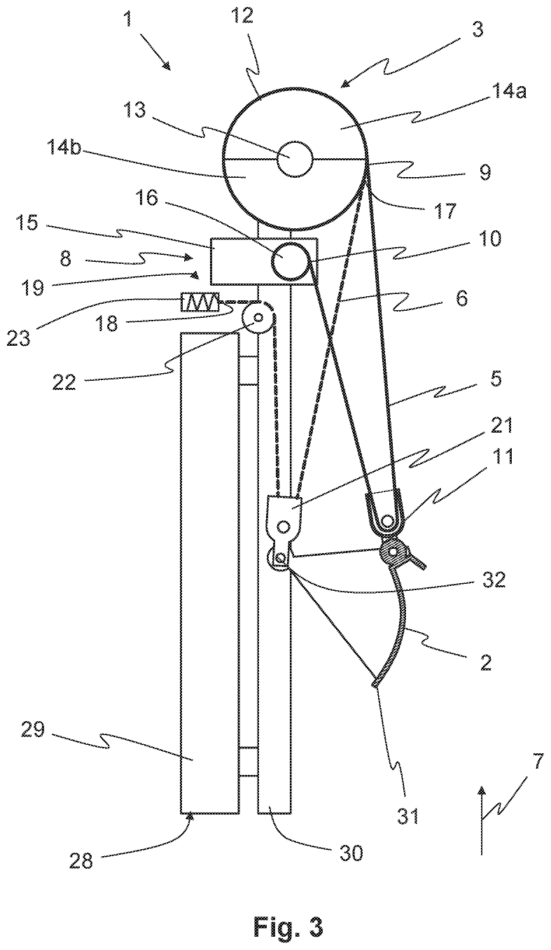

FIG. 1 shows a perspective view of a screen cleaning device 1, this being shown alone. Advantageously, the screen cleaning device 1 is arranged on a screen 29, as is shown in FIGS. 2 and 3, in order to clean a bar rack 28 there. In addition, the individual components of the screen cleaning device 1 are shown without a holding fixture or mounting for the sake of clarity.

The screen cleaning device 1 has at least one clearing element 2 for picking up and removing screenings. As depicted in the exemplary embodiment shown, the clearing element 2 is preferably in the shape of a shovel such that screenings can be easily picked up and transported along a lifting direction 7.

The screen cleaning device 1 has at least one lifting winch 3 so that the clearing element 2 can be moved along the lifting direction 7. The clearing element 2 is moved along the lifting direction 7 by winding and unwinding a first pulling means 4, a second pulling means 5 and/or a third pulling means 6. In the exemplary embodiment shown, the first pulling means 4 and the third pulling means 6 are spaced apart from one another along a transverse direction 27 of the screen cleaning device 1 and/or arranged at the ends of the clearing element 2. In the exemplary embodiment shown, the first pulling means 4 and the third pulling means 6, in particular in the form of a lifting cable or a lifting chain, have the task of moving the clearing element 2 upward and downward along the lifting direction 7. The first pulling means 4 and the third pulling means 6, in the exemplary embodiment shown, are connected to the lifting winch 3 by means of a drum-side end 17.

The screen cleaning device 1 additionally includes at least one actuating device 8, by means of which the second pulling means 5 can be manipulated such that the clearing element 2 is swiveled between a clearing position and an open position when the second pulling means 5 is manipulated. The second pulling means 5 is connected to the lifting winch 3 at a first end 9 and to the actuating device 8 at a second end 10 and is guided via a return mechanism 11 which is mounted on the clearing element 2. In the exemplary embodiment shown, the second pulling means 5, in particular in the form of a control cable or a control chain, has the task of swiveling the clearing element 2 between the clearing position and the open position.

The lifting winch 3 has one drum 12 for each pulling means 4, 5, 6 for winding the pulling means 4, 5, 6. Therefore, the lifting winch 3 in the exemplary embodiment shown includes three drums 12 for the three pulling means 4, 5, 6. The drums 12 are accommodated by means of a drum shaft 13. The drum shaft 13 is driven by a lifting drive 24. The at least one drum 12 is divided into at least two drum elements 14a, 14b, in particular two drum halves, in order to more easily mount the at least one drum 12 on the drum shaft 13. In addition, the drums 12 in the exemplary embodiment shown have grooving 20 or are provided with grooving 20. The respective pulling means 4, 5, 6 can be accommodated in the respective grooving 20 in the drums 12 during winding.

The actuating device 8 in the exemplary embodiment shown is in the form of an actuating winch, the actuating winch including at least one actuating drive 15 and one actuating drum 16. The second pulling means 5 are secured on the actuating drum 16 with the second end 10, as a result of which the second pulling means 5 can be wound and unwound on the actuating drum 16 when the actuating drum 16 is driven by the actuating drive 15. The actuating drum 16 can also be provided with grooving 20 in order to more easily wind and unwind the second pulling means 5.

As mentioned above, the drum-side end 17 of the first pulling means 4 and/or of the third pulling means 6 is connected to the lifting winch 3. Preferably, the drum-side end 17 of the first pulling means 4 and/or of the third pulling means 6 is/are secured on at least one of the drums 12 of the lifting winch 3. One bearing-side end 18 of the first pulling means 4 and/or of the third pulling means 6 is connected to a bearing device 19 in each case. The screen cleaning device 1 has at least one further return mechanism 21 for deflecting the first pulling means 4 and/or the third pulling means 6. In the exemplary embodiment shown, the screen cleaning device 1 has two further return mechanisms 21 for deflecting the first pulling means 4 and the third pulling means 6. The respective drum-side end 17 and the respective bearing-side end 18 of the first pulling means 4 and of the third pulling means 6 are located on different sides of the respective further return mechanism 21.

The return mechanism 11 and the two further return mechanisms 21 are preferably non-displaceably and rotatably mounted on the clearing element 2 as depicted in the exemplary embodiment shown. In this way, it can be ensures that force is transmitted from the clearing element 2 onto the lifting winch 3, the at least one bearing device 19 and the actuating device 8.

If the clearing element 2 is moved along the lifting direction 7, the actuating device 8 is preferably stopped. The pulling means 4, 5, 6 are wound or unwound on the respective drum 12 of the lifting winch 3. If the pulling means 4, 5, 6 are wound by means of the lifting winch 3, the clearing element 2 moves upward with the return mechanism 11 and the further return mechanisms 21. During this upward movement, the clearing element 2 is preferably in the clearing position shown here.

Thereafter, the clearing element 2 can be swiveled from the clearing position into the open position by means of the actuating device 8. If the actuating device 8 is in the form of an actuating winch, the second pulling means 5 can be wound onto the actuating drum 16. The lifting winch 3 is preferably stopped. Subsequent to the swiveling, the clearing element 2 can be moved downward into the open position, which is not shown here. The pulling means 4, 5, 6 are unwound by means of the lifting winch 3 for this purpose. The weight force of the clearing element preferably brings about the downward movement. Once the clearing element 2 has reached the lower end point, the clearing element 2 is preferably swiveled back into the clearing position by means of the actuating device 8. The second pulling means 5 can be unwound from the actuating drum 16 by means of the actuating device 8, which is in the form of an actuating winch.

In addition, in the exemplary embodiment shown, each of the bearing devices 19 has a bearing roller 22 and a spring 23. The first pulling means 4 and the third pulling means 6 in the exemplary embodiment shown are each guided via a bearing roller 22 and are connected to the spring 23 at the respective bearing-side end 18. As a result, the first pulling means 4 and the third pulling means 6 can be resiliently mounted. The bearing roller 22 can compensate for the spring movement.

In addition, the screen cleaning device 1 in the exemplary embodiment shown includes a control unit 25 and at least one sensor 26. By means of the at least one sensor 26, the position of the lifting winch 3, of the lifting drive 24, of the actuating drive 15, of the actuating drum 16 and/or of the clearing element 2 can be determined. The at least one sensor 26 preferably includes at least one position switch, one rotary encoder and/or one gearbox limit switch for determining the position of the aforementioned features. For this purpose, the control unit 25 is operatively connected to the lifting drive 24, the actuating device 8 and/or to the at least one sensor 26 such that the screen cleaning device 1 can carry out the above-described method.

FIGS. 2 and 3 each show a schematic cutaway side view of a screen cleaning device 1 arranged on a screen 29 according to another exemplary embodiment. The screen 29 is used substantially to separate out and remove screenings from a flowing liquid, for example, wastewater. The exemplary embodiments from FIGS. 2 and 3 are substantially a simplified representation of the screen cleaning device 1 of the exemplary embodiment from FIG. 1.

The sectional representation extends normally to the transverse direction 27 centrally through the return mechanism 11 and the actuating device 8 from FIG. 1. Since the exemplary embodiments from FIGS. 2 and 3 are a sectional representation, the first pulling means 4, as is shown in FIG. 1, is cut off. In addition, the second pulling means 5 are shown as a solid line and the third pulling means 6 are shown as a dashed line for the sake of clarity.

In contrast to the exemplary embodiment from FIG. 1, the screen 29 is shown with the bar rack 28 in the exemplary embodiments from FIGS. 2 and 3. The screen cleaning device 1 has a frame 30 for mounting the screen cleaning device 1 on the screen 29 and/or for accommodating the lifting winch 3, the actuating device 8, the bearing device 19, the control unit 25 and/or the at least one sensor 26. The frame 30 and the screen 29 are shown merely schematically or partially in the exemplary embodiment shown.

In FIG. 2, the clearing element 2 is arranged in the clearing position. In the clearing position, at least a portion of a shovel surface 31, on which, for example, rake teeth can be arranged, rests against the bar rack 28 and/or projects at least partially with the rake teeth into the bar rack 28. If the clearing element 2 is swiveled from the clearing position into the open position by means of the actuating device 8, a force acts on the return mechanism 11 in the lifting direction 7 via the second pulling means 5. The third pulling means 6 and the first pulling means 4 (not shown) merely hold the weight force of the clearing element 2 and are stopped.

Due to the fact that a force acts on the return mechanism 11 in the lifting direction 7 and the further return mechanism 21 is stopped during swiveling, the clearing element 2 is swiveled, for example, about a swivel point 32. The swivel point 32 in the exemplary embodiment shown is located in the region of the further return mechanism 21 and at a mounting of the further return mechanism 21 on the clearing element 2. Since the screen cleaning device 1 is formed in the region of the first pulling means 4 (see FIG. 1), a swivel point 32 can also be formed here. These two swivel points 32 form a swivel axis, about which the clearing element 2 swivels. Subsequent to the swiveling, the clearing element 2 is in the open position. The open position of the clearing element is shown in FIG. 3.

The present subject matter is not limited to the exemplary embodiments that have been represented and described. Modifications within the scope of the claims are also possible, as is any combination of the features, even if they are represented and described in different exemplary embodiments.

### LIST OF REFERENCE CHARACTERS

1 screen cleaning device
2 clearing element
3 lifting winch
4 first pulling means
5 second pulling means
6 third pulling means
7 lifting direction
8 actuating device
9 first end
10 second end
11 return mechanism
12 drum
13 drum shaft
14a, 14b drum element
15 actuating drive
16 actuating drum
17 drum-side end
18 bearing-side end
19 bearing device
20 grooving
21 further return mechanism
22 bearing roller
23 spring
24 lifting drive
25 control unit
26 sensor
27 transverse direction
28 barrack
29 screen
30 frame
31 shovel surface
32 swivel point

1-18. (canceled)

19. A screen cleaning device for cleaning a bar rack of a screen used to separate out and remove screenings from a flowing liquid, the screen cleaning device comprising:
at least one clearing element for picking up and removing screenings retained by the screen;
a lifting winch relative to which a first pulling means and a second pulling means can be wound and unwound, the clearing element being moved along a lifting direction as the first and second pulling means are wound and unwound relative to the lifting winch, and
at least one actuating device configured to manipulate the second pulling means such that the clearing element is swiveled between a clearing position and an open position,
wherein the second pulling means is connected to the lifting winch at a first end and to the actuating device at a second end, and wherein the second pulling means is guided via a return mechanism is mounted on the clearing element.

20. The screen cleaning device of claim 19, further comprising a third pulling means configured to be wound and unwound relative to the lifting winch, the first and third pulling means being spaced apart from one another along a transverse direction of the screen cleaning device and/or being arranged at opposed ends of the clearing element.

21. The screen cleaning device of claim 20, wherein a drum-side end of the first pulling means and of the third pulling means is connected to the lifting winch and a bearing-side end of the first pulling means and of the third pulling means is connected to at least one bearing device.

22. The screen cleaning device of claim 21, wherein the at least one bearing device includes a bearing roller configured to guide and/or deflect at least one of the first pulling means or the third pulling means.

23. The screen cleaning device of claim 21, wherein the at least one bearing device includes at least one spring secured to the bearing-side end of the first pulling means and/or the third pulling means.

24. The screen cleaning device of claim 20, wherein the screen cleaning device includes at least one additional return mechanism for deflecting the first pulling means and/or the third pulling means.

25. The screen cleaning device of claim 19, wherein at least one of the first pulling means or the second pulling means is in the form of a cable or a chain.

26. The screen cleaning device of claim 19, wherein the lifting winch includes at least one drum for winding and unwinding the first and second pulling means and a drum shaft for accommodating the at least one drum.

27. The screen cleaning device of claim 26, wherein the at least one drum comprises a plurality of drums accommodated on the drum shaft, wherein the first and second pulling means are each associated with a respective drum of the plurality of drums.

28. The screen cleaning device of claim 26, wherein the at least one drum is divisible into at least two drum elements.

29. The screen cleaning device of claim 26, wherein the at least one drum and/or the drum shaft are/is provided with grooving on a periphery thereof such that the first and second pulling means can be wound and unwound inside the grooving.

30. The screen cleaning device of claim 26, wherein the lifting winch includes a lifting drive configured to drive the drum shaft.

31. The screen cleaning device of claim 19, wherein the actuating device is configured as an actuating winch, the actuating winch including an actuating drive and an actuating drum, wherein the actuating drive drives the actuating drum to wind and unwind the second pulling means.

32. The screen cleaning device of claim 31, wherein the actuating drum is provided with grooving on the periphery such that the second pulling means can be wound and unwound inside the grooving.

33. The screen cleaning device of claim 19, wherein the screen cleaning device includes a control unit, the control unit being operatively connected to the lifting drive and/or to the actuating device.

34. The screen cleaning device of claim 33, further comprising at least one sensor operatively connected to the control unit, the at least one sensor being configured to provide an indication of a position of the at least one clearing element.

35. The screen cleaning device of claim 34, wherein the at least one sensor comprises at least one of a position switch, a gearbox limit switch, or a rotary encoder.

36. The screen cleaning device of claim 1, further comprising a frame configured to accommodate the lifting winch and the actuating device.

37. A screen for separating out and removing screenings from a flowing liquid, the screen comprising:
a bar rack; and
a screen cleaning device according to claim 1, the screen cleaning device being configured to clean the bar rack.
